(19) United States
(12) Patent Application Publication
(10) Pub. No.: US 2024/0391081 A1
(43) Pub. Date: Nov. 28, 2024

(54) Hand-Held Power Tool with a State-Determining Unit

(71) Applicant: Robert Bosch GmbH, Stuttgart (DE)

(72) Inventor: Tibor Kovacs, Debrecen (HU)

(21) Appl. No.: 18/696,917

(22) PCT Filed: Jul. 18, 2022
(86) PCT No.: PCT/EP2022/070103

§ 371 Date: Mar. 28, 2024

(30) Foreign Application Priority Data
Oct. 5, 2021 (DE) 10 2021 211 195.5

(51) Int. Cl. B25F 5/02; B25F 5/00

(52) U.S. Cl. CPC B25F 5/02; B25F 5/001

(57) ABSTRACT

A hand-held power tool includes a tool receptacle and a housing in which a drive unit for driving the tool receptacle is arranged. An operating element is provided for activating the drive unit. A state-determining unit is provided which, during a current handling of the hand-held power tool, is configured to determine the overall usage state of the hand-held power tool after a current handling based on a previous overall usage state of the hand-held power tool, a current handling time of the hand-held power tool, a current power consumption of the hand-held power tool, and an insert tool currently being used together with the hand-held power tool.

### PRIOR Art

The present invention relates to a hand-held power tool comprising a tool receptacle and a housing in which a drive unit for driving the tool receptacle is arranged, wherein an operating element for activating the drive unit is provided.

Such a hand-held power tool comprising a tool receptacle and a housing in which a drive motor is arranged to drive the tool receptacle is known from the prior art. The hand-held power tool comprises an operating element to activate the drive unit.

### DISCLOSURE OF THE INVENTION

The invention relates to a hand-held power tool comprising a tool receptacle and a housing in which a drive unit for driving the tool receptacle is arranged, wherein an operating element for activating the drive unit is provided. A state-determining unit is provided which, during a current handling of the hand-held power tool, is designed to determine the overall usage state of the hand-held power tool after a current handling on the basis of a previous overall usage state of the hand-held power tool, a current handling time of the hand-held power tool, a current power consumption of the hand-held power tool, and an insert tool currently being used together with the hand-held power tool.

The invention thus enables the provision of a hand-held power tool, in which a safe and reliable determination of an overall usage state of the hand-held power tool can be enabled by the state-determining unit. Thus, an unwanted failure of the hand-held power tool, in particular due to a comparatively poor overall usage state, can be prevented and a new acquisition of a corresponding hand-held power tool can be planned at least on time.

Preferably, the state-determining unit is associated with a time measurement unit configured to determine the current handling time of the hand-held power tool by measuring an operation time duration of the operating element during the current handling.

Thus, the current handling time can be determined in a straightforward manner.

The time measurement unit is preferably arranged in the area of the operating element.

A straightforward and reliable arrangement of the time measurement unit in the direct vicinity of the operating element can thus be enabled.

According to one embodiment, the state-determining unit is associated with a power measurement unit configured to determine the current power consumption of the hand-held power tool during the current handling based on a measurement of a current power consumption of the drive unit.

This enables the power measurement to accurately and reliably determine the current power consumption.

The power measurement unit is preferably arranged in the area of the drive unit.

This enables a suitable arrangement of the power measurement unit in the area of the drive motor.

According to one embodiment, the state-determining unit is associated with an insert tool identification unit configured to identify the insert tool when an insert tool is arranged in the tool receptacle for the current handling.

This enables a simple and straightforward identification of the insert tool for documentation purposes.

The insert tool identification unit preferably comprises a memory and a sensor, wherein the sensor is configured to detect an identification pattern of an insert tool arranged in the tool receptacle, wherein the identification pattern is arranged on a front face of the insert tool facing the drive unit, and wherein the insert tool identification unit is configured to identify the insert tool arranged in the tool receptacle by a comparison of the detected identification pattern with a plurality of identification patterns stored in the memory.

This enables a simple and reliable identification of the insert tool.

The sensor is preferably arranged on the tool receptacle and is displaceable with the tool receptacle in the axial direction towards the drive unit.

This allows for a suitable arrangement of the sensor in a simple manner.

Preferably, the state-determining unit is associated with a memory configured to store the previous overall usage state as well as the overall usage state after the current handling, wherein the overall usage state after the current handling replaces the previous overall usage state after the current handling.

This allows data detected in relation to the overall usage state to be saved easily and straightforwardly.

Preferably, a data transfer unit is provided for transmitting data, which represent the overall usage state according to the current handling, to an external device.

This allows for a secure and reliable transfer of the data.

### BRIEF DESCRIPTION OF THE DRAWINGS

The invention is explained in further detail in the following description with reference to exemplary embodiments shown in the drawings. The figures show:

FIG. 1 a side view of a hand-held power tool having a state-determining unit,

FIG. 2 a side view of an insert tool identification unit associated with the state-determining unit of FIG. 1 for identifying an insert tool, and

FIG. 3 a plan view of a sensor associated with the insert tool identification unit of FIG. 2 and an insert tool having an identification pattern for identification by the sensor.

### DESCRIPTION OF THE EXEMPLARY EMBODIMENTS

Elements having the same or a comparable function are provided with the same reference characters in the drawings and are described in detail only once.

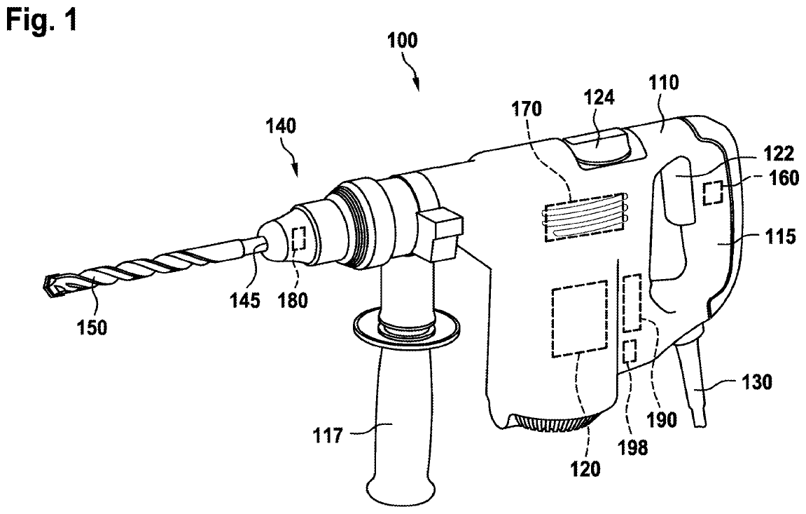

FIG. 1 shows an example of a hand-held power tool 100 comprising a housing 110, in which a drive unit 120 for preferably rotatably driving a tool holder 140 is arranged. The tool holder 140 comprises a tool receptacle 145 to receive an insert tool 150 and, in operation, rotates about an associated axis of rotation.

Illustratively, the hand-held power tool 100 is provided with a power cable 130 for the mains-dependent power supply, but can alternatively be operable, e.g., independently of the grid. As an example, the hand-held power tool 100 is configured as a percussion drill. According to one embodiment, the hand-held power tool 100, in particular the drive unit 120, comprises a percussion mechanism.

Preferably, the drive unit 120 comprises at least one drive motor. The drive motor is preferably designed as an electrically commutated motor. The drive unit 120, in particular the drive motor, can preferably be switched on and off via a manual switch 122, wherein the manual switch 122 is illustratively arranged on a handle 115 of the housing 110.

Optionally, the drive unit 120 may comprise a switchable transmission. The corresponding switchable transmission may be designed as a planetary transmission. Here, a shift element 124 may be associated with the switchable transmission to switch between at least two different gear steps. Furthermore, an optional additional handle 170 is provided. Illustratively, the additional handle 170 is arranged between the tool holder 140 and the drive unit 120.

According to the invention, the hand-held power tool 100 comprises a state-determining unit 160, 170, 180, 190 which, during a current handling of the hand-held power tool 100, is designed to determine the overall usage state of the hand-held power tool 100 after a current handling on the basis of a previous overall usage state of the hand-held power tool 100, a current handling time of the hand-held power tool 100, a current power consumption of the hand-held power tool 100, and/or an insert tool 150 currently being used together with the hand-held power tool 100. Preferably, the state-determining unit 160, 170, 180, 190 is associated with a time measurement unit 160 configured to determine the current handling time of the hand-held power tool 100 by measuring an operation time duration of the operating element 122 during the current handling. The time measurement unit 160 starts a time measurement upon activation of the operating element 122, and stops the time measurement upon deactivation of the operating element 122. According to one embodiment, the time measurement unit 160 is arranged in the area of the operating element 122. However, the time measurement unit 160 may also be arranged at any other location of the hand-held power tool 100.

Furthermore, the state-determining unit 160, 170, 180, 190 is preferably associated with a power measurement unit 170 configured to determine the current power consumption of the hand-held power tool 100 during the current handling based on a measurement of a current power consumption of the drive unit 120. Preferably, the power measurement unit 170 is arranged in the area of the drive unit 120. However, the power measurement unit 170 may also be arranged in any other location of the hand-held power tool 100.

Furthermore, the state-determining unit 160, 170, 180, 190 is preferably associated with an insert tool identification unit 180 configured to identify the insert tool 150, or a corresponding type of insert tool, when an insert tool 150 is arranged in the tool receptacle 145 for the current handling. The insert tool identification unit 180 preferably comprises a memory 190 and a sensor (320 in FIG. 3). The insert tool identification unit 180 is configured to identify the insert tool 150 arranged in the tool receptacle 145 by comparing the detected identification pattern (310 in FIG. 3) with a plurality of identification patterns stored, for example, in the memory 190. In this case, for example, different insert tools have different identification patterns. The identification patterns can be stored in a database and/or manually entered into a database.

Optionally, the state-determining unit 160, 170, 180, 190 is associated with a memory, e.g., the memory 190, configured to store the previous overall usage state as well as the overall usage state after the current handling. The overall usage state after the current handling is also referred to as the “current overall usage state” hereinafter for simplicity and clarity of the description. The current overall usage state replaces the previous overall usage state after the current handling.

It is noted that a plurality of memories can also be provided so that the identification patterns of insert tools can be stored in one memory and corresponding overall usage states can be stored in a further memory. Furthermore, the identification patterns and the overall usage states may also be stored in a common memory.

A data transfer unit 198 is optionally provided for transmitting data representing the current overall usage state to an external device. Data transfer via the data transfer unit 198 is wired or wireless. Here, the data transfer unit 198 may comprise a USB interface for data transfer. Alternatively, the data transfer unit 198 may be configured to perform data transfer over an internet connection. Such an internet connection may be configured wired or wirelessly via LAN or Wi-Fi. The determined data can be stored on a server and/or entered into a database of a software.

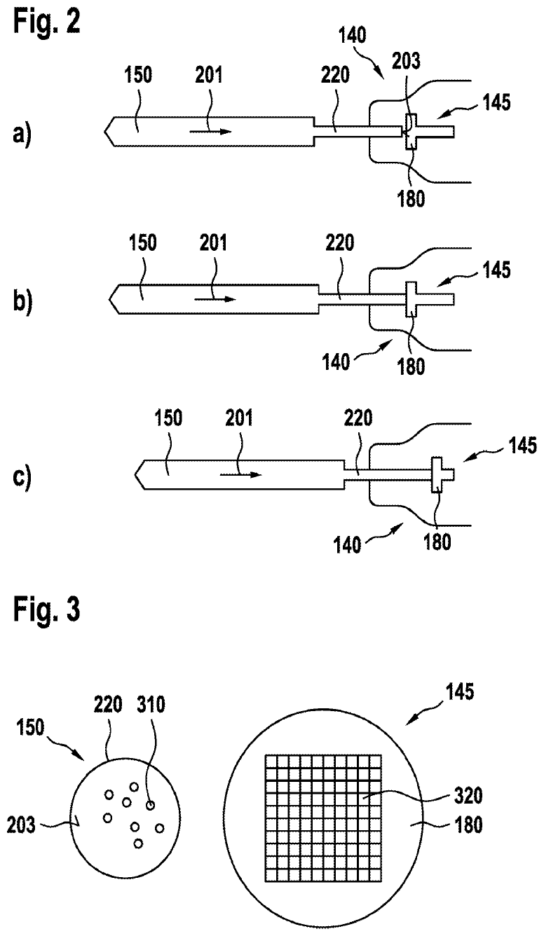

FIG. 2 shows the tool holder 140 with the tool receptacle 145 of FIG. 1 when the insert tool of FIG. 1 is arranged in the tool receptacle 145, as well as the insert tool identification unit 180 of FIG. 1. Here, FIG. 2 shows the arrangement of the insert tool identification unit 180 at a free end of the tool receptacle 145. Furthermore, FIG. 2 illustrates the insert tool 150 of FIG. 1, which has a receiving shaft 220 for arrangement in the tool receptacle 145.

In an area a) of FIG. 2, the insert tool 150 is arranged with its front face 203 facing the tool receptacle 145 in the direction of an arrow 201 towards the tool receptacle 145. However, the insert tool 150 is not received in the tool receptacle 145.

In an area b) of FIG. 2, the insert tool 150 is displaced towards the insert tool identification unit 180 in the direction of the arrow 201. The front face 203 of the insert tool 150 abuts the insert tool identification unit 180.

In an area c) of FIG. 2, the insert tool 150 is further displaced along the arrow 201 towards the tool receptacle 145, wherein the receiving shaft 220 of the insert tool 150 preferably acts on the insert tool identification unit 180 and the tool receptacle 145 to the illustrative right. As a result, the insert tool identification unit 180 and the tool receptacle 145 are illustratively displaced to the right compared with area a) and b).

FIG. 3 shows the tool receptacle 145 with the insert tool identification unit 180 of FIG. 1 and FIG. 2, as well as the front face 203 of the receiving shaft 220 of the insert tool of FIG. 1 and

FIG. 2. The insert tool identification unit 180 preferably comprises a sensor 320, which is preferably configured to detect an identification pattern 310 of the insert tool 150 arranged in the tool receptacle 145. The identification pattern 310 is preferably arranged on the front face 203 of the insert tool 150 facing the drive unit 120. The insert tool identification unit 180 is configured to identify the insert tool 150 arranged in the tool receptacle 145 by comparing the detected identification pattern 310 with a plurality of identification patterns stored in the memory 190 of the state-determining unit 160, 170, 180, 190 of FIG. 1.

Preferably, the sensor 320 is arranged on the tool receptacle 145 and is displaceable with the tool receptacle 145 in the axial direction 201 of FIG. 2 towards the drive unit 120. According to one embodiment, the identification pattern 310 of the insert tool 150 is configured as an axial extension, and the insert tool identification unit 180 determines the insert tool 150 or a corresponding type of insert tool, by applying the identification pattern 310 against the sensor 320 towards the drive unit 120, using the identification pattern 310.

1. A hand-held power tool comprising:
a tool receptacle;
a drive unit configured to drive the tool receptacle;
a housing in which the drive unit is arranged;
an operating element configured to activate the drive unit; and
a state-determining unit configured, during a current handling of the hand-held power tool, to determine an overall usage state of the hand-held power tool after a current handling based on (i) a previous overall usage state of the hand-held power tool, (ii) a current handling time of the hand-held power tool, (iii) a current power consumption of the hand-held power tool, and (iv) an insert tool currently used with the hand-held power tool.

2. The hand-held power tool according to claim 1, wherein the state determining unit is associated with a time measurement unit configured to determine the current handling time of the hand-held power tool by measuring an operation time duration of the operating element during the current handling.

3. The hand-held power tool according to claim 2, characterized in that wherein the time measurement unit is arranged in an area of the operating element.

4. The hand-held power tool according to claim 1, wherein the state determining unit is associated with a power measurement unit configured to determine the current power consumption of the hand-held power tool during the current handling based on a measurement of a current power consumption of the drive unit.

5. The hand-held power tool according to claim 4, wherein the power measurement unit is arranged in an area of the drive unit.

6. The hand-held power tool according to claim 1, wherein the state-determining unit is associated with an insert tool identification unit configured to identify the insert tool for the current handling when the insert tool is arranged in the tool receptacle.

7. The hand-held power tool according to claim 6, wherein:
the insert tool identification unit comprises a memory and a sensor,
the sensor is configured to detect an identification pattern of the insert tool arranged in the tool receptacle,
the identification pattern is arranged on a front face of the insert tool facing the drive unit, and
the insert tool identification unit is configured to identify the insert tool arranged in the tool receptacle by a comparison of the detected identification pattern with a plurality of identification patterns stored in the memory.

8. The hand-held power tool according to claim 7, wherein the sensor is arranged on the tool receptacle and is displaceable with the tool receptacle in an axial direction towards the drive unit.

9. The hand-held power tool according to claim 1, wherein:
the state-determining unit is associated with a memory configured to store the previous overall usage state and the overall usage state after the current handling, and
the overall usage state after the current handling replaces the previous overall usage state after the current handling.

10. The hand-held power tool according to claim 1, further comprising:
a data transfer unit configured to transmit data to an external device,
wherein the transmitted data represents the overall usage state according to the current handling.
